(19) United States
(12) Patent Application Publication
(10) Pub. No.: US 2005/0013452 A1
(43) Pub. Date: Jan. 20, 2005

(54) Loudspeaker based on the " center of percussion" or the " sweet spot" point, with gas filled hollow oscillating member and fluid flooded voice coil

(76) Inventor: Andrei N. Ilies, Lincoln Wood, IL (US)

Correspondence Address: ANDREI ILIES, 7007 N. HAMLIN AVE., LINCOLN WOOD, IL, 60712, US

(21) Appl. No.: 10/618,309

(22) Filed: Jul. 14, 2003

(51) Int. Cl. H04R 25/00; H04R 11/02

(52) U.S. Cl. 381/152; 381/431

(57) ABSTRACT

A loudspeaker, having a not necessarily rectangular, planar or constant thickness oscillating member, made of relatively thick, low density, stiff, acoustic insulating material, in an elongated form, surrounded by a solid frame, supporting the oscillating member in a minimum number of pivots or flexible elements, placed in areas of points of specific dynamic balance, like one end, center of mass and center of percussion about a certain axis of the oscillating member. The oscillating member is set in vibration by a permanent magnet driver having the voice coil attached to the oscillating member and the permanent magnet assembly supported by a bridge mounted across the frame. In an alternative preferred embodiment the oscillating member is built to incorporate at least one cavity filled with air or a gas different from air. In an alternative preferred embodiment the horizontally placed oscillating member has at least one voice coil immersed in a heat transferring fluid introduced in the cavity of the electromagnetic driver.

### REFERENCES CITED [REFERENCED BY]

U.S. Patent Documents

U.S. Pat. No. 4,003,449 January, 1977 Bertani 181/173. U.S. Pat. No. 4,184,563 January, 1980 Bertani 181/171. U.S. Pat. No. 4,257,325 March, 1981 Bertani 181/172. U.S. Pat. No. 4,997,058 March, 1991 Bertani 181/166. U.S. Pat. No. 5,007,707 April, 1991 Bertani 359/444. U.S. Pat. No. 5,425,107 June, 1995 Bertani 381/426. U.S. Pat. No. 5,693,91 December, 1997 Bertani 181/173. U.S. Pat. No. 5,615,275 March, 1997 Bertani 381/431. U.S. Pat. No. 6,058,196 May, 2000 Heron 381/152. U.S. Pat. No. 6,160,898 December, 2000 Bachmann 381/425. U.S. Pat. No. 6,278,90 Aug., Davis 381/398.

### BACKGROUND OF THE INVENTION

This invention relates to loudspeakers, but is not limited to the subject.

The dynamic loudspeakers having an electromagnetic driver coil attached to a membrane, which is brought to oscillation are mainly of two categories, the cone type, including the dome type loudspeakers and the planar type loudspeakers. The main disadvantage of the cone type loudspeakers, including the hard and soft dome loudspeakers, is the fact that they act in a piston like motion. This means that in general every point of the membrane will move about in phase, with few exceptions. Their membranes are in general also very thin compared to their other three dimensions. These two facts, when analyzed from the energetic point of view, will bring about the limitations of this concept. Part of the incoming electrical energy, transformed into mechanical energy by the electromagnetic driver, will be lost through heat, due to the inertial forces of reaction of the mass of the entire oscillating assembly. Also part of the acoustic energy in front of the oscillating membrane will be cancelled in the very instant of sound creation due to the acoustic transparency of the membrane, which will not be able to block in a satisfactory way the acoustic waves in opposition of phase generated on the rear side of the membrane. The planar loudspeakers have in general their membrane made of stiff, low density material or an assembly of materials, having in general a substantial thickness compared to the cone type loudspeakers, which makes them more efficient for this reason, as well as for the fact that part of them favor the propagation of mechanical oscillation energy in form of transversal waves along and across the membrane. In this case the generation of acoustic waves will occur as a consequence of a wiping motion of the membrane over the mass of air in the very proximity of the membrane. This effect can be felt as a continuous air pressure zone on the front and backside of the membrane. The efficiency of energy transfer is superior in this case, because it happens with considerably less dissipation due to inertial reaction from the part of the membrane.

The disadvantage of a generally stiff and thick membrane is that it is not able to allow the propagation of transversal waves in two different directions, perpendicular in general, without the introduction of unwanted stresses in the material it is made of. These stresses, over a certain amplitude of oscillation, start distorting the sound over a permissible limit.

Certain designs of planar loudspeakers have adopted an elongated shape of the membrane and the advantages are noticeable, but the unnecessary internal stressing of their poorly balanced membrane will still bring about a high level of distortion.

There is an obvious need to improve on the efficiency and accuracy of sound reproduction, as well as sizing, light weight and economical manufacturing of loudspeakers in general. The present invention addresses all these requirements.

### DESCRIPTION

### BRIEF SUMMARY OF THE INVENTION

The present invention describes a loudspeaker having an oscillating member built of a relatively thick, sound absorbing, stiff, low density material, like balsa wood, plastic material foam, or a composite system. The shape of the oscillating member is elongated and generally not planar, not rectangular and not of even thickness, which are only a small number of the many possibilities dictated by functional, ornamental and economical requirements. The ratio of maximum length over maximum width over maximum thickness is in general, but not restricted to, 33 to 3 to 1, going up to 72 to 4 to 1, in case of a one on a row voice coil version. Due to its highly elongated shape, the oscillating member will favor the propagation of oscillating mechanical energy as transversal waves in the predominant direction of it, the longitudinal direction.

The sound is created as effect of a wiping action of the oscillating member on the mass of air in the proximity of its surface. By allowing for a combination of piston like motion of portions of the oscillating member and predominant transversal oscillation to occur and by being able to acoustically insulate the front from the backside, the proposed loudspeaker in the preferred embodiment will have a high efficiency. To attain an also high level of sound reproduction quality, in the preferred embodiment of the present invention, the oscillating member of the loudspeaker is attached to its surrounding frame in a minimum number of joints of pivoting or unidirectional flexing type, set in case of the pivoting elements in pairs along the width of the frame and in case of the flexing elements, along the width of the frame, on one or both ends of the oscillating member.

These joints allow only one degree of freedom of motion and in case of the pivoting type absorb the least amount of energy, allowing for the greatest freedom of movement.

By making the presumption that, due to its highly elongated shape and given the relative stiffness of the oscillating member, as well as the relative high rate of vibration with small amplitude compared to the length of the oscillating member, the oscillating member behaves in its motion like a solid stick, it becomes obvious that the most dynamically stable state will be reached if the oscillating member would be forced to swing around an axis, which could be in the preferred embodiment of the invention, one end of the oscillating member, the center of mass of the entire oscillating member or any conveniently chosen point along the oscillating member. By choosing, in an alternative to the preferred embodiment of the invention, to have the axis of rotation in the area of the first end of the oscillating member and the voice coil placed in the point where the rotational inertia of the part of the oscillating member between the first end of the oscillating member and that point, will equal the rotational inertia of the remaining part of the oscillating member about the same axis, will induce vibrations in the oscillating member with no reaction in the axis of rotation. This very point is called “Center of Percussion” and is defined in the Webster Encyclopedic Dictionary as: “The point on a rigid body, suspended so as to be able to move freely about a fixed axis, at which the body may be struck without changing the position of the axis.”

In an alternative to the preferred embodiment of the invention the center of mass of the entire oscillating member is considered to execute a translation movement, while the parts of the oscillating member on one or both sides of the center of mass of the entire oscillating member are considered to swing around the center of mass of the entire oscillating member. The principle of the center of percussion can be applied to one or both of these two parts of the oscillating member, having generated this way one or two points along the oscillating member where the dynamic forces balance themselves in the way of not inducing reactions in the point of the center of mass of the entire oscillating member, or where the reaction is under the form of a “sting”, meaning that for one oscillation of the voice coil there will be only one oscillation of that very point.

In a second alternative to the preferred embodiment of the invention, furthermore the two sides apart from the center of mass of the entire oscillating member can be considered as moving their centers of masses in a translation and only their parts aside from their centers of mass towards the ends of the entire oscillating member will rotate around the respective centers of mass of the very parts of the oscillating member. This development will bring about two additional points where the inertial forces show balance in a particular case, that is, no reactions in the center of mass of the two parts of the entire oscillating member on each side of the center of mass of the entire oscillating member. These two points, if used as locations for pivoting points, would bring about an outstanding dynamic stability for the entire oscillating member, translated in acoustic terms, the highest quality of sound attainable from the system. The voice coil in this case is placed the best in the center of mass of the entire oscillating member.

In a third alternative to the preferred embodiment of the invention, the places of the pivoting points from the second alternative to the preferred embodiment of the invention, are taken by voice coils, while one pivot is installed in the center of mass of the entire oscillating member and two pivots or two flexible elements are installed, one at each end of the oscillating member.

Another alternative to the preferred embodiment of the invention is to create a cavity or cavities inside the oscillating member to enable a closer control of density and distribution of mass. Also, the replacement of the air inside the cavity or cavities with a suitable gas, will improve the sound dumping inside the oscillating member by changing the sound speed inside the cavities with immediate effect on sound pitch, and consequently directivity and reflection, A rubber bladder is installed in the proximity of the oscillating member, connected to the cavities, to compensate for the variation in volume of the gas due to temperature changes.

In a last alternative to the preferred embodiment of the invention, the loudspeaker is held in a horizontal position with the gap of the permanent magnetic assembly surrounding the voice coil facing upwards. In this position, and having the central part of the permanent magnetic assembly provided with an opening that communicates from the front side of the oscillating member with the cavity of the permanent magnetic assembly, a heat exchanging fluid can be introduced around the voice coil. This will enable the loudspeaker to handle higher power loads as well as improve the dumping of free oscillations where necessary.

The result is an unprecedented quality of sound and efficiency, compact and economical to manufacture loudspeaker, as presented in the preferred embodiment of the invention and further accompanied by drawings that illustrate the principles of the invention.

### BRIEF DESCRIPTION OF THE DRAWINGS

The various advantages and features of the invention will be further brought forward by the following discussion taken in conjunction with the set of drawings, in which:

FIG. 1a is a rear view of the loudspeaker, as one alternative to the preferred embodiment of the invention.

FIG. 1b is a left view of FIG. 1a.

FIG. 1c is a partial section on the line A-A of FIG. 1a.

FIG. 2a is a rear view of the loudspeaker, as a second alternative to the preferred embodiment of the invention.

FIG. 2b is a left view of FIG. 2a.

FIG. 2c is a right view of FIG. 2a.

FIG. 3a is a rear view of the loudspeaker, as a third alternative to the preferred embodiment of the invention.

FIG. 3b is a left view of FIG. 3a.

FIG. 4a is the rear view of the loudspeaker, as a fourth alternative to the preferred embodiment of the invention.

FIG. 4b is the left view of FIG. 4a.

FIG. 5a is a section on the line D-D in FIG. 5c.

FIG. 5b is a section on the line B-B in FIG. 5a.

FIG. 5c is the right side view of the oscillating member, as an alternative to the preferred embodiment of the invention.

FIG. 6a is a section on the line F-F of FIG. 6c.

FIG. 6b is a section on the line E-E in FIG. 6a of the entire oscillating member.

FIG. 6c is the right view of the oscillating member, as an alternative to the preferred embodiment of the invention.

FIG. 7a is the rear view of the loudspeaker, as an alternative to the preferred embodiment of the invention.

FIG. 7b is a partial section on the line G-G of FIG. 7a.

FIG. 8a is a section on the line H-H of FIG. 8b.

FIG. 8b is the rear view of the loudspeaker, as an alternative to the preferred embodiment of the invention.

### DETAILED DESCRIPTION OF THE INVENTION

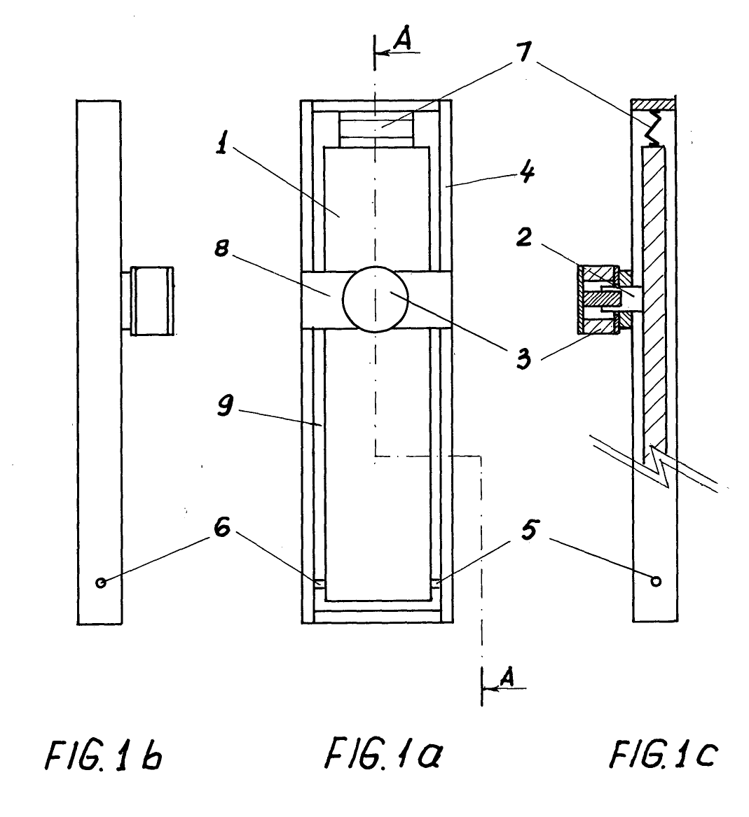

FIG. 1a is showing the loudspeaker as the oscillating member (I) surrounded by the solid frame (4). The permanent magnet assembly (3) is mounted on the bridge (8). The pair of pivoting points (5) and (6) is holding the first end of the oscillating member (1). The flexible element (7) is holding the second end of the oscillating member (1) and attaches to the frame (4). An air gap (9) is present between the frame (4) and the oscillating member (1). The position of the voice coil is centered over the width of the oscillating member and is in the area of the center of percussion of the entire oscillating member about the axis of the points (5) and (6) in one alternative to the preferred embodiment of the invention. The vibrations induced by the voice coil in the oscillating member will not be transferred into the pair of pivots (5)-(6) according to the principle of “The Center of Percussion”. It looks as if the vibration is not affected by the presence of this pair of pivots, which is actually the case. In dynamic terms this translates into the fact that the loudspeaker can function without the pair (5)-(6) of pivots, which means that the flexible element (7) is the only reaction introduced from the frame (4) into the oscillating member besides the magnetic driver. The only function of the flexible element (7) is the alignment of voice oil inside the permanent magnet driver and its design keeps its all other influences low. This means that the oscillating member finds itself in an almost ideal condition, that of floating.

The voice coil can also be placed, as in another alternative to the preferred embodiment of the invention, in the center of percussion of the part of the oscillating member between the center of mass of the entire oscillating member and the second end of the oscillating member, that is the point of attachment of the flexible element (7) to the oscillating member, about the axis along the width of the frame and through the center of mass of the entire oscillating member. In this case, according to the principle of “The Center of Percussion”, the center of mass of the entire oscillating member will not move, which brings about the fact that the entire oscillating member in its instantaneous translation movement induced by the voice coil will not move. From the dynamic point of view it seems like the entire oscillating member is “frozen” in place. The oscillating member (1) will act upon the pair of points (5)-(6) in a very particular way, that is, for every one movement of the voice coil, there will be the same qualitative movement tendency in the opposite direction into the pair of pivots (5)-(6). The reaction of the pair of pivots (5)-(6) will be equal in size, but opposite to the action of the oscillating member, which means that the pair of pivots in question is acting on the oscillating member in phase with the voice coil and without introducing free oscillations. The pair of pivoting points (5)-(6), being of a rigid nature will induce vibrations in the oscillating member just like a voice coil would. Their action will be as if a virtual voice coil had been created. The experimental research proves this fact.

FIG. 1b is showing the position of the pivoting point (6).

FIG. 1c is showing the alignment of the voice coil (2) inside the permanent magnet driver (3). The pivoting point (5) can also be seen.

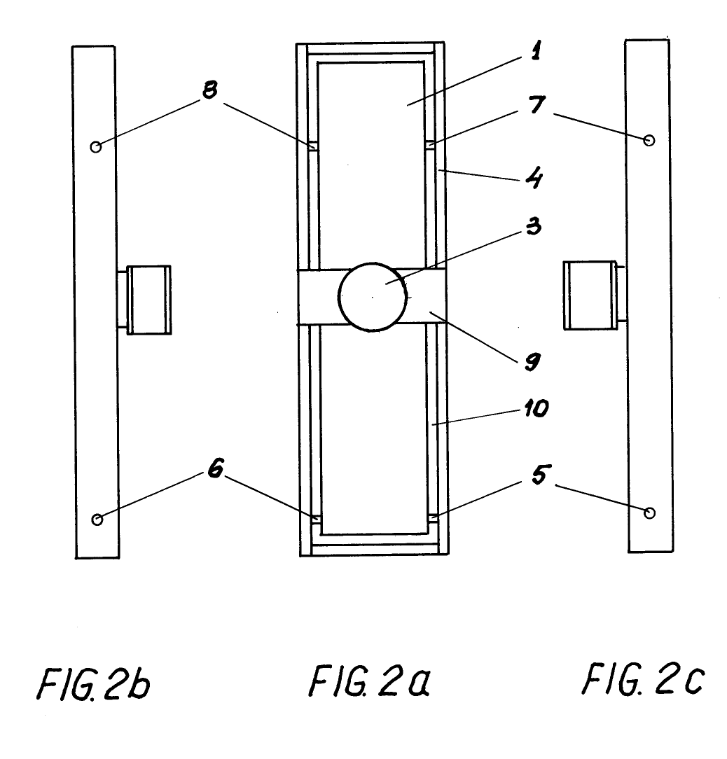

FIG. 2a is showing the rear view of a loudspeaker in which the oscillating member (1) is attached to the solid frame (4) by means of two pairs of pivoting points, (5)-(6) and (7)-(8). In all the rest of its surrounding the oscillating member is separated from the solid frame through the air gap (10). The voice coil is attached to the oscillating member (1) in this particular case in the area of the center of mass of the entire oscillating member. The permanent magnet (3) is mounted to the bridge (9), which is mounted onto the frame (4). The first end of the oscillating member is suspended between the pair (5)-(6) of pivoting points. The second pair (7)-(8) of pivoting points attaches to the oscillating member (1) along the line of the center of percussion of the part of the oscillating member between the center of mass of the entire oscillating member and the second end of the oscillating member, about the axis of the center of mass of the entire oscillating member.

FIG. 2b is showing the pivoting points (6) and (8).

FIG. 2c is showing the pivoting points (5) and (7).

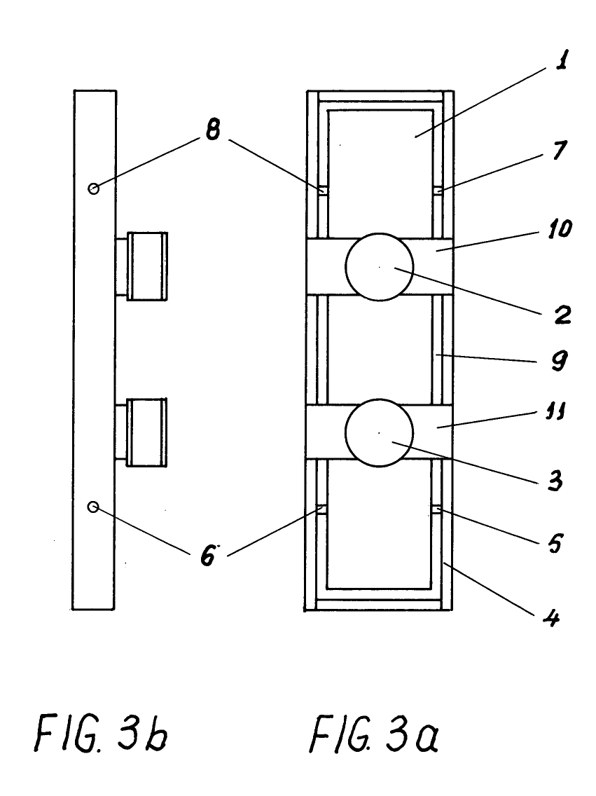

FIG. 3a is showing a loudspeaker with two permanent magnetic drivers. The oscillating member (1) attaches to the frame (4) through two pairs of pivoting points (5)-(6) and (7)-(8). The center of the voice coil inside the permanent magnet assembly (3) finds itself along the width of the oscillating member (1) in the axis of the center of percussion of the entire oscillating member (1) about the axis of the upper end of the oscillating member. The voice coil inside the permanent magnetic assembly (2) finds itself along the width of the oscillating member (1) in the axis of the center of percussion of the entire oscillating member (1) about the axis of the lower end of the oscillating member (1). The pair (5)-(6) of pivots finds itself along the line crossing the width of the oscillating member (1) through the center of mass of the part of the oscillating member (1) between the center of the voice coil inside the permanent magnetic assembly (3) and the lower end of the oscillating member (1). The pair (7)-(8) of pivots finds itself along the line crossing the width of the oscillating member (1) through the center of mass of the part of the oscillating member (1) between the center of the voice coil inside the permanent magnetic assembly (2) and the upper end of the oscillating member (1). The air gap is separating the rest of the oscillating member (I) from the solid frame (4). The permanent magnet driver (2) is mounted on the bridge (10), which is attached to the frame (4). The permanent magnet driver (3) is mounted on the bridge (11), which is attached to the frame (4).

FIG. 3b is showing the position of the pivoting points (6) and (8), as well as the position of the two centers C1 and C2 of the two voice coils.

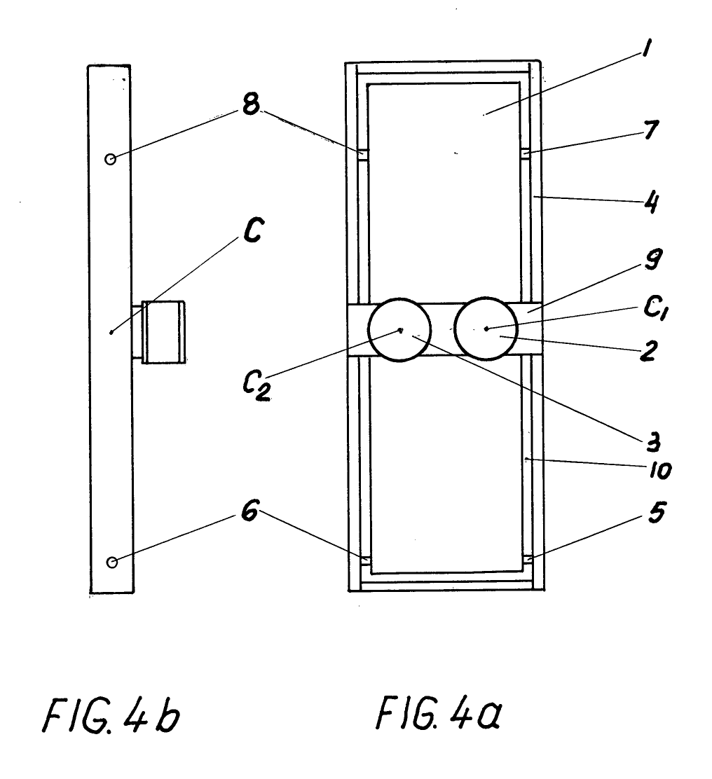

FIG. 4a is showing a loudspeaker having two permanent magnet drivers (2) and (3) in a row, on the same bridge (9). The oscillating member (1) is attached to the solid frame (4) through two pairs of pivoting points (5)-(6) and (7)-(8). An air gap (10) is separating the rest of the oscillating member (1) from the frame (4).

The centers C1 and C2 of the voice coils lined up in the permanent magnet drivers, (2) and (3) are attached along the width of the oscillating member (1), in a line through the center of mass of the entire oscillating member (1). The pair (5)-(6) of pivots is suspending the oscillating member (1) around the lower end of it.

The pair (7)-(8) of pivots is suspending the oscillating member (1) on the line of the center of percussion of the upper half of the oscillating member (1) about the center C, which is the center of mass of the entire oscillating member (1).

FIG. 4b is showing the position of the pivoting points (6) and (8) and the center of mass C of the entire oscillating member.

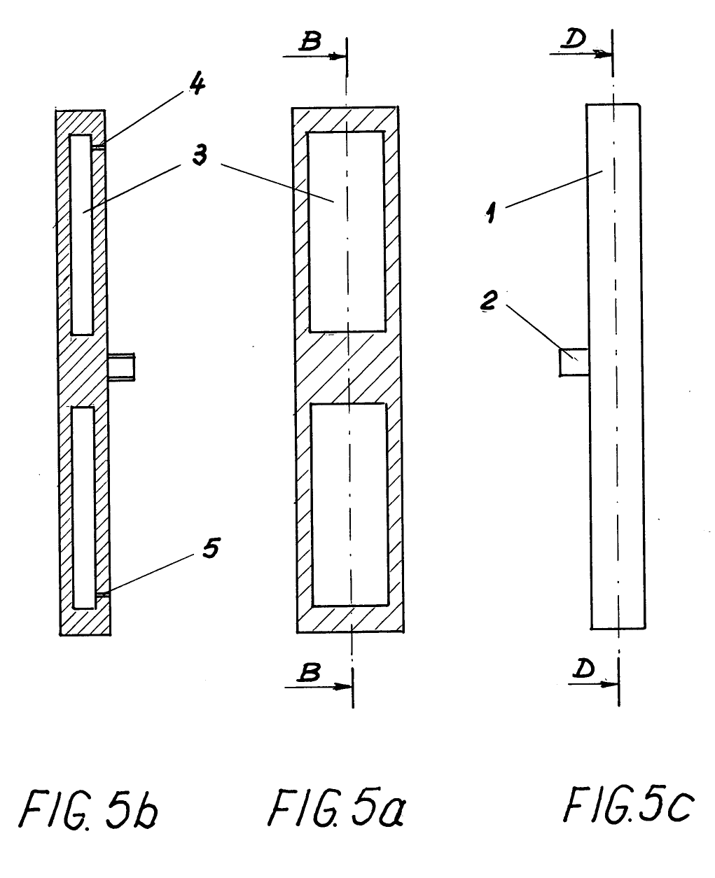

FIG. 5a is showing cavities (3) and (6) of the oscillating member (1) removed from a loudspeaker.

FIG. 5b is sowing the small diameter holes (4) and (5) that allow the cavities (3) and (6) to communicate with the outside atmosphere in order to equalize pressures. Also the inside shape in cross section of the cavities can be seen.

FIG. 5c is showing the voice coil (2) attached on the oscillating member (1) of a loudspeaker.

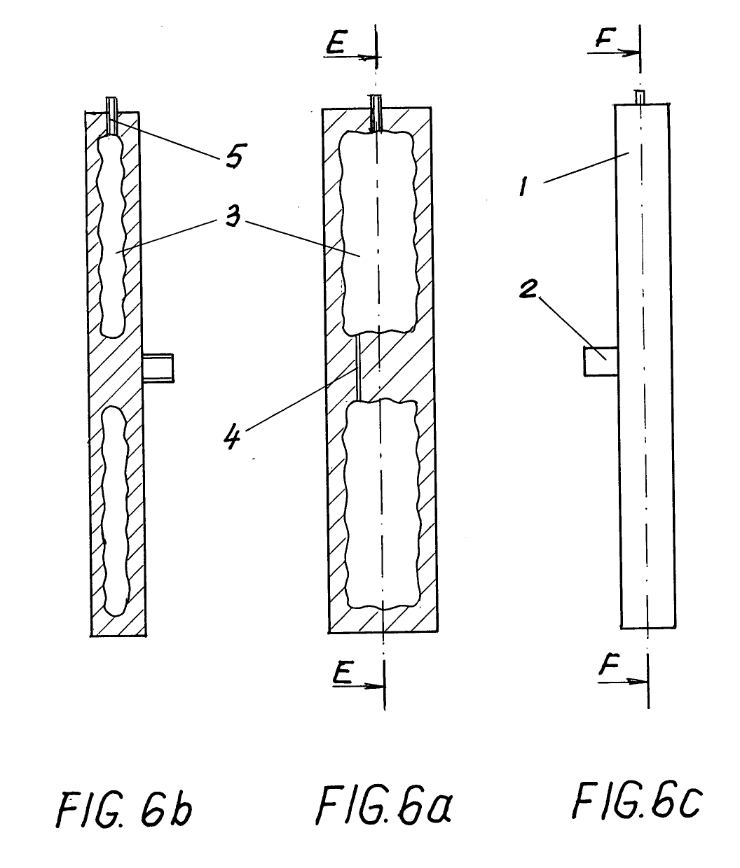

FIG. 6a is showing a cross section of an oscillating member removed from a loudspeaker. The small diameter hole (4) is connecting the cavities (3) and (6).

FIG. 6b is showing the tube (5) used to fill the cavities (3) and (6) with gas. Also the inside shape of the two cavities can be seen.

FIG. 6c is showing the voice coil (2) attached to the oscillating member (1).

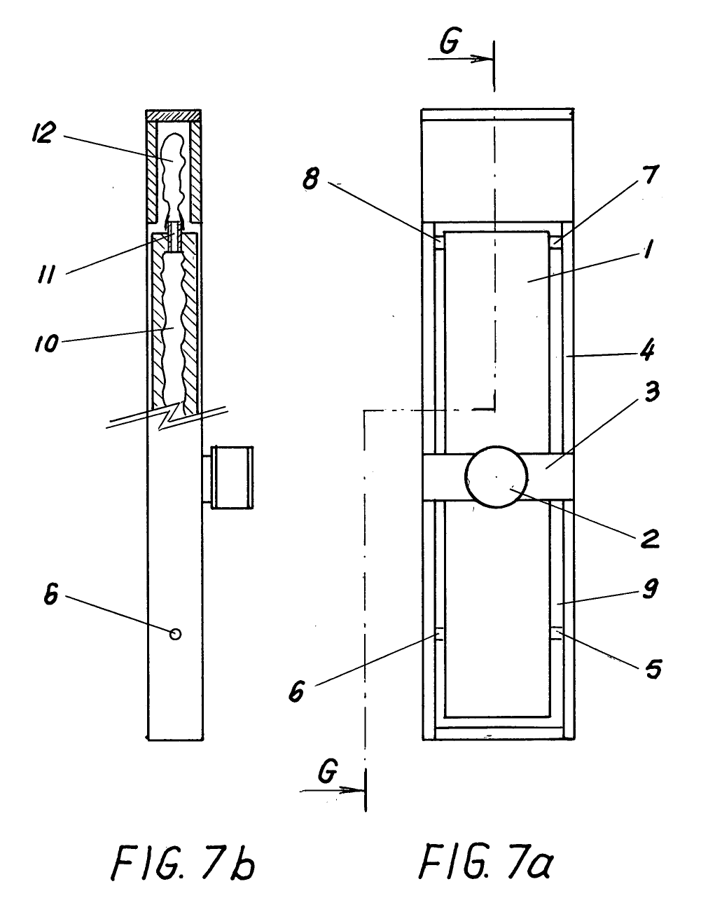

FIG. 7a is showing a loudspeaker built with the oscillating member shown in FIG. 6a. The oscillating member (1) is suspended between two pairs of pivoting points (5)-(6) and (7)-(8). The pair (7)-(8) of pivoting points is holding the upper end of the oscillating member (1). The second pair (5)-(6) of pivoting points is placed in the area of the center of percussion of the lower half of the oscillating member (1) about the center of mass of the entire oscillating member (1). The permanent magnet driver (2) is seen as attached to the bridge (3), which is mounted onto the frame (4). The air gap (9) finds itself between the oscillating member (1) and the frame (4).

FIG. 7b is showing the position of the pivoting point (6). The rubber bladder (12) is attached to the tube (11) and communicates with cavity (10). The bladder in its enclosure can hold about 35% of the total quantity of gas in the cavities inside the oscillating member and is meant to take up the volume change of gas inside the cavities due to temperature change without considerably pressurizing the cavities.

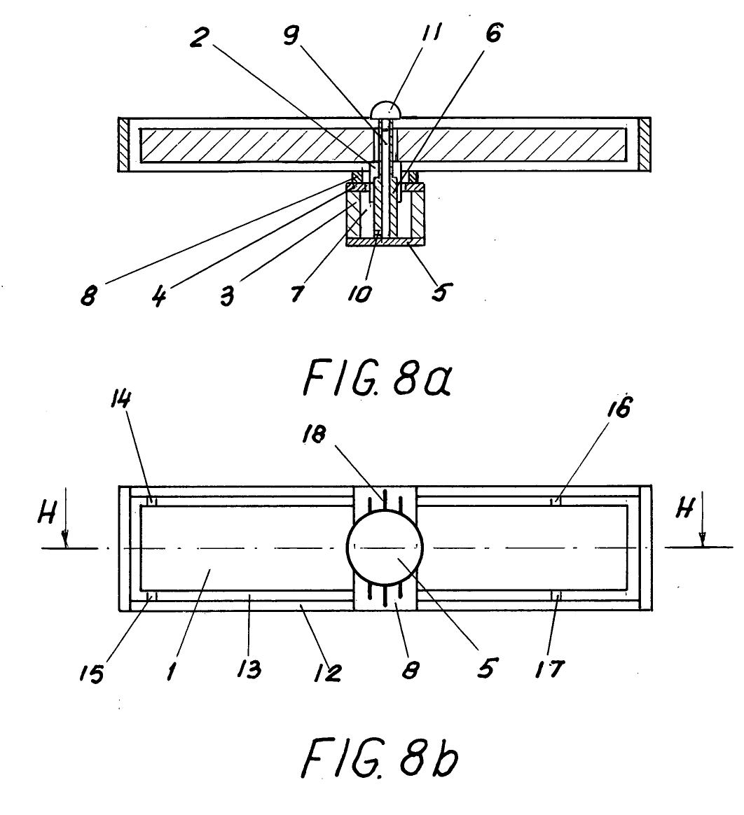

FIG. 8a is showing a loudspeaker in a horizontal position. The voice coil (2) fits in the gap of the flange (4) of the permanent magnet driver assembly mounted on the bridge (8). The permanent magnet (3) is attached to the flange (4) and (5) creating the cavity (7). The central part (6) of the permanent magnet assembly extends to the front side of the loudspeaker. The opening (9) communicates with the cavity (7) through the opening (10). The decorative plug (11) closes the opening (9). In an alternative to the preferred embodiment the cavity (7) is filled with fluid in order to increase the cooling capacity of the voice coil. Much higher power can be handled this way by the loudspeaker and also the voice coil dumping of free oscillation is improved.

FIG. 8b is showing the oscillating member (1) of the loudspeaker described in FIG. 8a. The flange (5) of the permanent magnet can also be seen. The fins (18) of the heat sink can be seen as being part of the bridge (8) itself. The air gap (13) finds itself between the oscillating member (1) and the frame (12). The pairs of pivoting points (14)-(15) and (16)-(17) are suspending the oscillating member (1) inside the frame (12). In an alternative to the preferred embodiment, the voice coil is mounted in the center of mass of the entire oscillating member. The pair (14)-(15) of pivoting points are suspending the oscillating member (1) at the first end. The pair (16)-(17) of pivoting points is mounted around the area of the center of percussion of the second half of the oscillating member about the axis of the center of mass of the entire oscillating member (1).

1. A loudspeaker comprising a rigid frame around an elongated relatively thick oscillating member made of stiff, low density and sound absorbing material. The oscillating member does not have to be rectangular or planar. The thickness does not have to be constant. At least one permanent magnetic driver has its voice coil attached to the backside of the oscillating member and its permanent magnet assembly mounted on a bridge along the width of the frame.
The oscillating member is mounted onto the frame via a minimum number of pivoting points distributed along the major dimension, which is lengthwise. These pivoting points are set in pairs along the second dimension of the oscillating member, which is the width. The axis of such pairs of pivoting points are chosen to cross certain points of interest along the first dimension of the oscillating member, the length, like one end of the oscillating member, the center of mass of the entire oscillating member, the center of mass of parts of the oscillating member, the center of percussion of the entire oscillating member about a certain axis of rotation or the center of percussion of parts of the oscillating member about a certain axis of rotation.
In a particular case a unidirectional flexing element can be installed at one or both ends in the longitudinal direction along the width of the oscillating member.

2. A loudspeaker, as described in claim 1, having the first end of the oscillating member mounted between a pair of pivots, the second end of the oscillating member mounted on a flexible element and the voice coil attached in the area of the center of percussion of the entire oscillating member about the first end of the oscillating member.

3. A loudspeaker, as described in claim 1, having the first end of the oscillating member mounted between a pair of pivots, the second end of the oscillating member mounted on a flexible element and the voice coil attached in the area of the center of percussion of the part of the oscillating member between the center of mass of the entire oscillating member and the second end of the oscillating member, about the axis of the center of mass of the entire oscillating member along the width of the oscillating member.

4. A loudspeaker, as described in claim 1, having the first end of the oscillating member mounted on a flexible element. The center of mass of the entire oscillating member finds itself on the axis of a pair of pivoting points. The second end of the oscillating member is mounted on a flexible element.
A first voice coil is attached in the area of the center of percussion of the part of the oscillating member between the first end of the oscillating member and the axis of the pivoting points, about the axis of the pair of pivoting points.
A second voice coil is attached in the area of the center of percussion of the part of the oscillating member between the axis of the pivoting points and the second end of the oscillating member, about the axis of the pivoting points.
Each voice coil works in conjunction with its own permanent magnet assembly mounted each on a bridge along the width of the loudspeaker.

5. A loudspeaker, as described in claim 4, having the first voice coil in the center of mass of part of the oscillating member between the first end of the oscillating member and the first center of percussion as defined in claim 4 and the second voice coil in the center of mass of part of the oscillating member between the second end of the oscillating member and the second center of percussion as defined in claim 4.

6. A loudspeaker as described in claim 1, having the first end of the oscillating member mounted between a first pair of pivoting points. A second pair of pivoting points is set in the area of the center of percussion of the entire oscillating member about the axis of the first pair of pivoting points.
The voice coil is attached in the area of the center of mass of the entire oscillating member.

7. A loudspeaker, as described in claim 1, having the first end of the oscillating member mounted between a first pair of pivoting points and the voice coil in the center of mass of the entire oscillating member. The second pair of pivoting points is installed in the area of the center of percussion of part of the oscillating member between the center of mass of the entire oscillating member and the second end of the oscillating member, about the axis of the center of mass of the entire oscillating member.

8. A loudspeaker, as described in claim 1, having a first pair of pivoting points around the center of percussion of the quarter of the entire oscillating member containing the first end of the entire oscillating member about the center of mass of the half of the entire oscillating member containing the first end of the entire oscillating member. The second pair of pivoting points is installed in the area of the center of percussion of the half of the entire oscillating member containing the second end of the entire oscillating member about the center of mass of the entire oscillating member.
The voice coil is placed in the area of the center of mass of the entire oscillating member.

9. A loudspeaker, as described in claim 1, having the voice coil in the center of mass of the entire oscillating member. The first pair of pivoting points is installed in the area of a first center of percussion of the part of the oscillating member between the first end of the oscillating member and the center of mass of the entire oscillating member, about the axis of the center of mass of the entire oscillating member. The second pair of pivoting points is installed in the area of a second center of percussion of the part of the oscillating member between the center of mass of the entire oscillating member and the second end of the oscillating member, about the center of mass of the entire oscillating member.

10. A loudspeaker, as described in claim 9, having the first pair of pivoting points shifted from the first center of percussion into the center of mass of part of the oscillating member from the first end of the oscillating member to the first center of percussion and the second pair of pivoting points shifted from the second center of percussion into the center of mass of part of the oscillating member between the second end of the oscillating member to the second center of percussion.

11. A loudspeaker, as described in claim 4, having no pivoting points in the area of the center of mass.

12. A loudspeaker, as described in claim 5, having no pivoting points in the area of the center of mass.

13. A loudspeaker, as described in claims 2,3,4,5,11 and 12, having instead of unidirectional flexing elements, in their location, a pair of pivoting points installed as in claim 1.

14. A loudspeaker, as described in claims 6,7,9 and 10, having the free overhanging ends of the oscillating member replaced with dynamic counterbalancing weights.

15. A loudspeaker, as described in claims 1,2,3,4,5,6,7,8,9,10,11,12,13 and 14, having at least one cavity in the oscillating member in order to control the average density and improve sound absorption. The cavity is air filled.

16. A loudspeaker, as described in claim 15, having the cavity filled with a gas, other than air.

17. A loudspeaker, as described in claims 1,2,3,4,5,6,7,8,9,10,11,12,13,14, 15 and 16, having at least two voice coils attached in a row along the width of the oscillating member in order to increase the width of the assembly without compromising the very concept of the present invention.

18. A loudspeaker, described in claims 1,2,3,4,5,6,7,8,9,10,11,12,13,14,15,16 and 17, set in a horizontal position, having the electromagnetic driver or drivers facing upwards, being able to hold a heat transferring fluid in the cavity of the permanent magnet assembly. The permanent magnet assembly or assemblies, if needed can be surrounded by stationary heat sink structures or even a fan forced cooling system.

19. A loudspeaker, as described in claims 1,2,3,4,5,6,7,8,9 and 10, having all pivoting points replaced with flexible elements.
